(19) United States
(12) Patent Application Publication
(10) Pub. No.: US 2004/0259736 A1
(43) Pub. Date: Dec. 23, 2004

(54) Biodegradable solid preparation of a phytopathologicalagent with delayed active substance release

(76) Inventors: Reinhold Dieing, Speyer (DE); Frank Dietsche, Schriesheim (DE); Marcos Gomez, Heidelberg (DE); Thomas Kessler, Schifferstadt (DE); Simone Schillo, Ludwigshafen (DE); Karl-Heinrich Schneider, Kelinkarlbach (DE); Karl-Otto Heilmann, Eisenberg (DE)

Correspondence Address: KEIL & WEINKAUF, 1350 CONNECTICUT AVENUE, N.W., WASHINGTON, DC, 20036, US

(21) Appl. No.: 10/490,368

(22) PCT Filed: Sep. 19, 2002
(86) PCT No.: PCT/EP02/10499

(30) Foreign Application Priority Data
Sep. 28, 2001 (DE) 101 48 052.0

(51) Int. Cl. A01N 25/10

(52) U.S. Cl. 504/360

(57) ABSTRACT

The present invention relates to a method for the preparation of a solid formulation of a slow-release crop protection product, which comprises carrying out a melt extrusion of a composition comprising 0.1 to 80% by weight of at least one fungicidal active ingredient, 0 to 80% by weight of at least one herbicidal, acaricidal, insecticidal or growth-regulatory active ingredient, 3 to 80% by weight of a thermoplastic, water-insoluble polymer from the group of the polylactides, 0 to 80% by weight of at least one thermoplastic water-insoluble polymer, 10 to 80% by weight of at least one mineral filler and 0 to 20% by weight of inorganic or organic additives, and subsequently shaping the extrudate, and to the solid formulations preparable by this method.

The present invention relates to a method for the preparation of a solid formulation of a slow-release crop protection product, which comprises carrying out a melt extrusion of a composition comprising

(a) 0.1 to 80% by weight of at least one fungicidal active ingredient;

(b) 0 to 80% by weight of at least one herbicidal, acaricidal or insecticidal or growth-regulatory active ingredient;

(c) 3 to 80% by weight of a thermoplastic, water-insoluble polymer from the group of the polylactides;

(d) 0 to 80% by weight of at least one thermoplastic polymer;

(e) 10 to 80% by weight of at least one mineral filler; and

(f) 0 to 20% by weight of inorganic or organic additives;

the total of components (a) to (f) being 100%, and subsequently shaping the extrudate. The present invention also relates to the formulations preparable by the method of the invention.

The formulations preparable by the method of the invention release the active ingredient(s) (a) and (b) obtained into the environment (soil, aqueous medium, plants) in a controlled and slow fashion (complete release within several days up to a few months). Formulations which release their active ingredients in a controlled and slow manner are generally referred to as slow-release formulations.

The controlled release provides for a bioavailability over a prolonged period which suits the intended purpose in question. For example, this is required in the case of active ingredients which are insufficiently persistent in the soil and/or the plant, in the case of active ingredients which are phytotoxic to the crop plant, or else in the case of applications, in which the active ingredient must be available, or released, over a prolonged period.

The invention therefore furthermore relates to a method of controlling phytopathogenic fungi, in which a formulation in solid form prepared in accordance with the invention is allowed to act on plants, their environment or on seed. Depending on whether one or more active ingredients of group (b) are used, the abovementioned method is also suitable for controlling undesired plant growth, undesired attack by insects or mites and/or for regulating the growth of plants.

The preparation of slow-release formulations comprising one or more pesticidal active ingredients, at least one mineral filler, inorganic or organic additives and at least one thermoplastic water-insoluble polymer by means of melt extrusion is known (WO 99/56540).

The granules prepared by the method described in WO 99/56540 are not always satisfactory under practice conditions with regard to their thermoplastic processibility and homogeneity. Secondly, the release rate of the active ingredient from this formulation is not adjustable.

It is an object of the present invention to develop a method for the preparation of a biodegradable slow-release formulation of crop protectants where

the formulation prepared is susceptible to granulation, solid, storage-stable and susceptible to sedimentation in water;

the release rate of the pesticidal active ingredient(s) of the slow-release formulations prepared is adjustable.

Surprisingly, it has been found that the above-described disadvantages can be avoided by adding polylactide. It has thus been found that this object is achieved by the melt extrusion of a mixture comprising

(a) 0.1 to 80% by weight of at least one fungicidal active ingredient; and

(b) 0 to 80% by weight of at least one herbicidal, acaricidal or insecticidal active ingredient; and

(c) 3 to 80% by weight of a thermoplastic, water-insoluble polymer from the group of the polylactides; and

(d) 0 to 80% by weight of at least one thermoplastic polymer; and

(e) 10 to 80% by weight of at least one mineral filler; and

(f) 0 to 20% by weight of inorganic or organic additives.

The release rate of the formulation prepared is specifically adjustable by the amount of the added polylactide (c).

Insoluble in water is understood as meaning that the polymeric binders (c) have a water solubility of less than 100 mg per liter of water at 20° C.

Thermoplastic water-insoluble polymers from the group of the polylactides (c) are based on polycondensates of lactic acid, [lacuna] are described, for example, in WO 97/41836, WO 96/18591, WO 94/05484, U.S. Pat. No. 5,310,865, U.S. Pat. No. 5,428,126, U.S. Pat. No. 5,440,008, U.S. Pat. No. 5,142,023, U.S. Pat. No. 5,247,058, U.S. Pat. No. 5,247,059 and U.S. Pat. No. 5,484,881. Others which must be mentioned in this context are polylactide copolymers which are described in WO 98/09613, U.S. Pat. No. 4,045,418, U.S. Pat. No. 4,057,537, Adv. Mater. 2000, 12, 1841-1846. They are suitable for the novel formulations.

Polylactides are commercially available from Cargill Dow LLC (for example PLA Polymer 404ID, PLA Polymer 4040D, PLA Polymer 4031D, PLA Polymer 2000D or PLA Polymer 1100) or from Mitsui Chemicals (Lactea).

These products take the form of polymers based on lactid acid lactones (A), which are converted into polylactid acid polymers (B) by ring-opening polymerization:

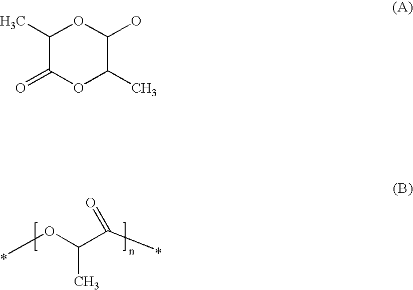

The degree of polymerization n in formula (B) is in the range of from 1000 to 4000, preferably 1500 to 3500 and especially preferably 1500 to 2000. These polymers are especially preferred as component (c) in the formulations according to the invention. Depending on the degree of polymerization, the average molar mass of these products is from 71 000 to 284 000 g/mol. Especially preferred polymers of the formula (B) have an average molar mass of from 118 000 g/mol (Lactea), 212 000 g/mol (PLA Polymer 4041D) or 223 000 g/mol (PLA Polymer 2000D).

The amount of the thermoplastic water-insoluble polymer from the group of the polylactides (c) in the total formulation can vary depending on the efficacy, release rate and processability. In general, the amount ranges from 3 to 80% by weight, preferably from 3 to 50% by weight and particularly preferably from 5 to 30% by weight based on the total formulation, under the condition that the formulation can still be subjected to thermoplastic processing.

Active ingredient (a) is at least one active ingredient selected from the class of the fungicides. Thus, combinations of more than one active ingredient from the class of fungicides are also in accordance with the invention. Suitable fungicides are the following:

sulfur, dithiocarbamates and their derivatives, such as iron(III) dimethyldithiocarbamate, zinc dimethyldithiocarbamate, zinc ethylenebisdithiocarbamate, manganese ethylenebisdithio-cabamate, manganese zinc ethylenediaminebisdithiocarbamate, tetramethylthiuram disulfide, ammonia complex of zinc (N,N-ethylene-bisdithiocarbamate), ammonia complex of zinc (N,N′-propylene-bisdithiocarbamate), zinc (N,N′-propylenebisdithiocarbamate), N,N′-polypropylenebis(thiocarbamoyl)disulfide;

nitro derivatives, such as dinitro(1-methylheptyl)phenyl crotonate, 2-sec-butyl-4,6-dinitrophenyl 3,3-dimethylacrylate, 2-sec-butyl-4,6-dinitrophenylisopropyl carbonate, diisopropyl 5-nitro-isophthalate;

heterocyclic substances, such as 2-heptadecyl-2-imidazoline acetate, 2,4-dichloro-6-(o-chloroanilino)-s-triazine, O,O-diethyl phthalimidophosphonothioate, 5-amino-1-[bis(dimethylamino)-phospinyl]-3-phenyl-1,2,4-triazole, 2,3-dicyano-1,4-dithio-anthraquinone, 2-thio-1,3-dithiolo[4,5-b]quinoxaline, methyl 1-(butylcarbamoyl)-2-benzimidazolecarbamiate, 2-methoxycarbonyl-aminobenzimisazole, 2-(2-furyl)benzimidazole, 2-(4-thiazolyl)-benzimidazole, N-(1,1,2,2-tetrachloroethylthio)tetrahydro-phtalimide, N-trichloromethylthiotetrahydrophthalimide, N-trichloromethylthiophthalimide, N-dichlorofluoromethylthio-N′,N′-dimethyl-N-phenylsulfodiamide, 5-ethoxy-3-trichloromethyl-1,2,3,-thiadiazole, 2-thiocyanatomethylthiobenzothiazole, 1,4-dichloro-2,5-dimethoxybenzene, 4-(2-chlorophenylhydrazono)-3-methyl-5-isoxazolone, pyridine-2-thio-1-oxide, 8-hydroxy-quinoline or its copper salt, 2,3-dihydro-5-carboxanilido-6-methyl-1,4-oxathiine, 2,3-dihydro-5-carboxanilido-6-methyl-1,4-oxathiine 4,4-dioxide, 2-methyl-5,6-dihydro-4H-pyran-3-carboxanilide, 2-methylfuran-3-carboxanilide, 2,5-dimethyl-furan-3-carboxanilide, 2,4,5-trimethylfuran-3-carboxanilide, N-cyclohexyl-2,5-dimethylfuran-3-carboxamide, N-cyclohexyl-2,5-dimethylfuran-3-carboxamide, N-cyclohexyl-N-methoxy-2,5-dimethylfuran-3-carboxamide, 2-methylbenzanilide, 2-iodobenzanilide, N-formyl-N-morpholine-2,2,2-trichloroethylacetal, piperazine-1,4-diylbis-1-(2,2,2-tri-chloroethyl)formamide, 1-(3,4-dichloroanilino)-1-formylamino-2,2,2-trichloroethane, 2,6-dimethyl-N-tridecylmorpholine or its salts, 2,6-dimethyl-N-cyclododecylmorpholine or its salts, N-[3-(p-tert-butylphenyl)-2-methylpropyl]-cis-2,6-dimethyl-morpholine, N-[3-(p-tert-butylphenyl)-2-methylpropyl]piperidine, 1-[2-(2,4-dichlorophenyl)-4-ethyl-1,3-dioxolan-2-ylethyl]-1H-1,2,4-triazole, 1-[2-(2,4-dichlorophenyl)-4-n-propyl-1,3-dioxolan-2-ylethyl]-1,2,4-triazole, N-(n-propyl)-N-(2,4,6-trichlorophenoxyethyl)-N′-imidazolylurea, 1-(4-chlorophenoxy)-3,3-dimethyl-1-(1H-1,2,4-triazole-1-yl)-2-butanone, 1-(4-chlorophenoxy)-3,3-dimethyl-1-(1H-1,2,4-triazole-1-yl)-2-butanol, (2RS,3RS)-1-[3-(2-chlorophenyl)-2-(4-fluorophenyl)-oxiran-2-ymethyl]-1H-1,2,4,-triazole, α(2-chlorophenyl)-α-(4chlorophenyl)-5-pyrimidinemethanol, 5-butyl-2-dimethyl-amino-4-hydroxy-6-methylpyrimidine, bis(p-chlorophenyl)-3-pyridinemethanol, 1,2-bis(3-ethoxycarbonyl-2-thioreido)-bezene,

anilinopyrimidines such as N-(4,6-dimethylpyrimidin-2-yl)-aniline, N-[4-methyl-6-(1-propynyl)pyrimidin-2-yl]aniline, N-[4-methyl-6-cyclopropylpyrimidin-2-yl]aniline,

phenylpyrroles such as 4-(2,2-difluoro-1,3-benzodioxol-4-yl)-pyrrole-3-carbonitrile,

cinnamamides such as 3-(4-chlorophenyl)-3-(3,4-dimethoxy-phenyl)acryloymorpholine,

and a variety of fungicides, such as dodecylguanidine acetate, 3-[3(3,5-dimethyl-2oxycyclohexyl]glutarimide, hexachlorobenzene, methyl N-(2,6-dimethylphenyl)-N-(2-furoyl)-DL-alaninate, DL-N-(2,6-dimethylphenyl)-N-(2′-methoxyacetyl)-alanine methyl ester, N-(2,6-dimethylphenyl)-N-chloroacetyl-D,L-2aminobutyrolactone, DL-N-(2,6-dimethylpheny)-N-(phenyl-acetyl)alanine methyl ester, 5-methyl-5-vinyl-3-(3,5-dichloro-phenyl)-2,4-dioxo-1,3-oxazolidine, 3-[3,5-dichlorophenyl-(5-methyl-5methoxymethyl]-1,3-oxazolidine, 3-]3,5-dichlorophenyl-(5-methyl-5-methoxymethyl]-1,3-oxazolidine-2,4-dione, 3-(3,5-dichlorophenyl)-1-isopropylcarbamoylhydantoin, N-(3,5-dichlorophenyl)-1,2-dimethylcyclopropane-1,2-dicarboximide, 2-cyano-[N-(ethylaminocarbonyl)-2-methoximino]acetamide, 1-[2-(2,4-dichlorophenyl)pentyl]-1H-1,2,4-triazole, 2,4-difluoro-α-(1H-1,2,4-triazolyl-1-methyl)-benzhydryl alcohol, N-(3-chloro-2,6-dinitro-4-trifluoromethylphenyl)-5-trifluoromethyl-3-chloro-2-aminopyridine, 1-((bis-(4-fluorophenyl)methylsilyl)methyl)-1H-1,2,4-triazole, N,N-dimethyl-5-chloro-2-cyano-4-p-tolylimidazole-1-sulfonamide, 3,5-dichloro-N-(3-chloro-1-ethyl-1-methyl-2-oxopropyl)-4-methyl-benzamide, carpropamid, 3-(2-propyloxy)-1,2-benzisothiazole 1,1-dioxide (probenazol), furamethpyr, diclometh, iprobenfos, iprodione, pyroquilon, tricyclazol, isoprothiolane, edifenphos, ferimzone, fludioxinil, pencycuron, flutolanil, mepronil, thifluzamid, iprodione, furametpyr,

strobilurins of the formula I:

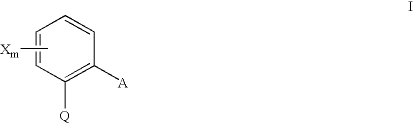

in which

X is halogen, C₁-C₄-alkyl or trifluoromethyl;

m is 0 or 1;

Q is C(═CH—CH₃)—COOCH₃, C(═CH—OCH₃)—COOCH₃, C(═N—OCH₃)—CONHCH₃, C(═N—OCH₃)—COOCH₃ or N(—OCH₃)—COOCH₃

A is —O—B, —CH₂O—B, —OCH₂—B, —CH═CH—B, —C═C—B, —CH₂O—N═C(R¹)—B or—CH₂O—N═C(R¹)—C(R²)═N—OR³, where

B is phenyl, naphthyl, 5-membered or 6-membered hetaryl or 5-membered or 6-membered heterocyclyl comprising one to three N atoms and/or one O or S atom or one or two O and/or S atoms, the ring systems being unsubstituted or substituted by one to three radicals R^{a}:

R^{a} is cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfoxyl, C₃-C₆-cycloalkyl, C₁-C₆-alkoxy, C₁-C₆-haloalkoxy, C₁-C₆-alkyloxy-carbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylamino-thiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered hetaryl, 5- or 6-membered hetaryloxy, C(Ra)═NOR^{β} or OC(R^{α})₂C(R^{β})═NOR^{β}, the cyclic radicals, in turn, being unsubstituted or substituted by one to three radicals R^{b}:

R^{b} is cyano, nitro, halogen, amino, amino-carbonyl, aminothiocarbonyl, C₁-C₆-alkyl, C₁-C₆-haloalkyl, C₁-C₆-alkylsulfonyl, C₁-C₆-alkylsulfoxyl, C₃-C₆-cycloalkyl, C₁-C₆-alkoxy, C₁-C₆-haloalkoxy, C₁-C₆-alkoxycarbonyl, C₁ -C₆-alkylthio, C₁-C₆-alkylamino, di-C₁ -C₆-alkylamino, C₁-C₆-alkylaminocarbonyl, di-C₁-C₆-alkyl-aminocarbonyl, C₁-C₆-alkylaminothio-carbonyl, di-C₁-C₆-alkylaminothiocarbonyl, C₂-C₆-alkenyl, C₂-C₆-alkenyloxy, C₃-C₆-cycloalkyl, C3-C₆-cycloalkenyl, phenyl, phenoxy, phenylthio, benzyl, benzyloxy, 5- or 6-membered heterocyclyl, 5- or 6-membered hetaryl, 5- or 6-membered hetaryloxy or C(R^{α})═NOR^{β};

R^{α}, R^{β}are hydrogen or C₁-C₆-alkyl;

R¹ is hydrogen, cyano, C₁-C₄-alkyl, C₁-C₄-haloalkyl, C₃-C₆-cycloalkyl, C₁-C₄-alkoxy;

R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a};

C₁-C₁₀-alkyl, C₃-C₆-cycloalkyl, C₂-C₁₀-alkenyl, C₂-C₁₀-alkynyl, C₁-C₁-C₁₀-alkylcarbonyl, C₂-C₁₀-alkenylcarbonyl, C₃-C₁₀-alkynylcarbonyl, C₁-C₁₀-alkylsulfonyl, or C(R^{α})═NOR^{β}, the hydrocarbon radicals of these groups being unsubstituted or substituted by one to three radicals R^{c}:

R^{c} is cyano, nitro, amino, aminocarbonyl, amino-thiocarbonyl, halogen, C₁-C₆-alkyl, C₁-C₆-halo-alkyl, C₁-C₆-alkylsulfonyl, C₁-C₆-alkylsulfoxyl, C₁-C₆-alkoxy, C₁-C₆-haloalkoxy, C₁-C₆-alkoxy-carbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylamino-thiocarbonyl, di-C₁-C₆-alkylaminothiocarbonyl, C₂-C₆-alkenyl, C₂-C₆-alkenyloxy,

C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy and hetarylthio, it being possible for the cyclic groups, in turn, to be partially or fully halogenated or to have attached to them one to three radicals R^{a}; and

R³ is hydrogen, C₁-C₆-alkyl, C₂-C₆-alkenyl, C₂-C₆-alkynyl, the hydrocarbon radicals of these groups being unsubstituted or substituted by one to three groups R^{c}, which may optionally be substituted by one to three radicals R^{a};

The use of strobilurins is preferred.

As regards their use, the compounds mentioned below are particularly preferred:

Methyl E-methoxyimino-[α-(o-tolyloxy)-o-tolyl]acetate (kresoxim-methyl), methyl E-2-{2-[6-(2-cyanophenoxy)-pyrimidin-4-yloxy]phenyl}-3-methoxy-acrylate (azoxystrobin), methyl E-methoxyimino-[α-(2-phenoxyphenyl)]acetamide (metominostrobin), methyl E-methoxyimino-[α-(2,5-dimethylphenoxy)-o-tolyl]acetamide(dimoxystrobin), methyl E-2-{2-[2-trifluoromethylpyridyl-6-]oxy-methyl]phenyl}-3-methoxyacrylate(picoxystrobin), methyl (E,E)-methoximino-{2-[1-(3-trifluoromethylphenyl)ethylidene-aminooxymethyl]phenyl}acetate(trifloxystrobin), methyl N-(2-{[1-(4-chlorophenyl)-1H-pyrazol-3-yl]oxymethyl}-phenyl)-N-methoxycarbamate(pyraclostrobin), and compounds of the formula I,

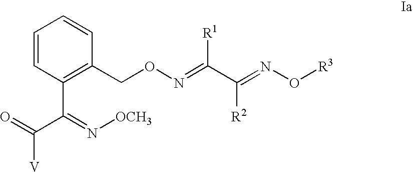

where

V is C₁-C₄-alkylamino or C₁-C₄-alkoxy,

R¹ is hydrogen, halogen, cyano, C₁-haloalkyl or C₁-C₄-alkyl,

R² is halogen, C₁-C₄-alkyl, C₁-C₆-alkoxy, C₁-C₆-alkenyl or C₁-C₄-haloalkyl, phenyl, halophenyl,

R³ is hydrogen, C₁-haloalkyl, C₁-C₄-alkyl, cyclopropyl, C₃-C₄-alkenyl or C₃-C₄-alkynyl.

Other especially preferred strobilurins are those of the formula Ib

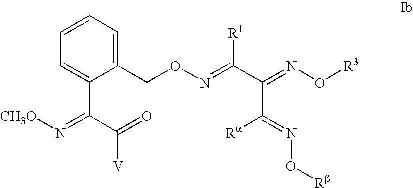

where

V is NHCH₃ or OCH₃;

R¹ is hydrogen, cyano, halogen, C₁-haloalkyl or C₁-C₄-alkyl;

R³ is hydrogen, C₁-haloalkyl, cyclopropyl, C₁-C₄-alkyl, C₃-C₄-alkenyl, C₃-C₄-alkynyl;

R^{α} is hydrogen, C₁-haloalkyl or C₁-C₄-alkyl;

R^{β} is hydrogen, C₁-haloalkyl, cyclopropyl, C₁-C₄-alkyl, C₃-C₄-alkenyl or C₃-C₄-alkynyl.

The active ingredients mentioned in the following tables are especially preferred:

TABLE I
Ia

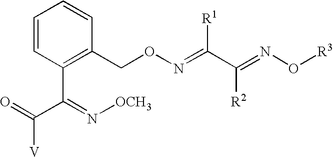

| No. | V | R¹ | R² | R³ | Reference |
|---|---|---|---|---|---|
| I-1 | OCH₃ | CH₃ | CH₃ | CH₃ | WO-A |
| | | | | | 95/18789 |
| I-2 | OCH₃ | CH₃ | CH(CH₃)₂ | CH₃ | WO-A |
| | | | | | 95/18789 |
| I-3 | OCH₃ | CH₃ | CH₂CH₃ | CH₃ | WO-A |
| | | | | | 95/18789 |
| I-4 | NHCH₃ | CH₃ | CH₃ | CH₃ | WO-A |
| | | | | | 95/18789 |
| I-5 | NHCH₃ | CH₃ | 4-F—C₆H₄ | CH₃ | WO-A |
| | | | | | 95/18789 |
| I-6 | NHCH₃ | CH₃ | 4-Cl—C₆H₄ | CH₃ | WO-A |
| | | | | | 95/18789 |
| I-7 | NHCH₃ | CH₃ | 2,4-C₆H₃ | CH₃ | WO-A |
| | | | | | 95/18789 |
| I-8 | NHCH₃ | Cl | 4-F—C₆H₄ | CH₃ | WO-A |
| | | | | | 98/38857 |
| I-9 | NHCH₃ | Cl | 4-Cl—C₆H₄ | CH₂CH₃ | WO-A |
| | | | | | 98/38857 |
| I-10 | NHCH₃ | CH₃ | CH₂C(═CH₂)CH₃ | CH₃ | WO-A |
| | | | | | 97/05103 |
| I-11 | NHCH₃ | CH₃ | CH═C(CH₃)₂ | CH₃ | WO-A |
| | | | | | 97/05103 |
| I-12 | NHCH₃ | CH₃ | CH═C(CH₃)₂ | CH₂CH₃ | WO-A |
| | | | | | 97/05103 |
| I-13 | NHCH₃ | CH₃ | CH═C(CH₃)CH₂CH₃ | CH₃ | WO-A |
| | | | | | 97/05103 |
| I-14 | NHCH₃ | CH₃ | O—CH(CH₃)₂ | CH₃ | WO-A |
| | | | | | 97/06133 |
| I-15 | NHCH₃ | CH₃ | O—CH₂CH(CH₃)₂ | CH₃ | WO-A |
| | | | | | 97/06133 |

and the following active ingredients known from WO-A 97/15552.

TABLE II
Ib

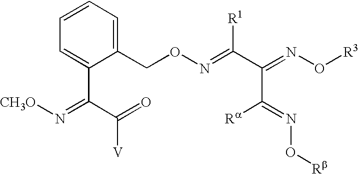

| No. | R¹ | R³ | R^{α} | R^{β} | V |
|---|---|---|---|---|---|
| II-1 | H | H | H | H | NHCH₃ |
| II-2 | H | CH₃ | H | CH₃ | NHCH₃ |
| II-3 | CH₃ | H | CH₃ | H | NHCH₃ |
| II-4 | CH₃ | CH₃ | CH₃ | CH₃ | NHCH₃ |
| II-5 | CH₃ | cyclo-C₃H₅ | CH₃ | cyclo-C₃H₅ | NHCH₃ |
| II-6 | CH₃ | CH₂CH₃ | CH₃ | CH₂CH₃ | NHCH₃ |
| II-7 | CH₃ | CH(CH₃)₂ | CH₃ | CH(CH₃)₂ | NHCH₃ |
| II-8 | CH₃ | CH₂CH═CH₂ | CH₃ | CH₂CH═CH₂ | NHCH₃ |
| II-9 | CF₃ | H | CF₃ | H | NHCH₃ |
| II-10 | CF₃ | CH₃ | CF₃ | CH₃ | NHCH₃ |
| II-11 | CF₃ | CH(CH₃)₂ | CF₃ | CH(CH₃)₂ | NHCH₃ |
| II-12 | CN | H | CH₃ | H | NHCH₃ |
| II-13 | CN | CH₃ | CH₃ | CH₃ | NHCH₃ |
| II-14 | H | H | H | H | OCH₃ |
| II-15 | H | CH₃ | H | CH₃ | OCH₃ |
| II-16 | CH₃ | H | CH₃ | H | OCH₃ |
| II-17 | CH₃ | CH₃ | CH₃ | CH₃ | OCH₃ |
| II-18 | CH₃ | cyclo-C₃H₅ | CH₃ | cyclo-C₃H₅ | OCH₃ |
| II-19 | CH₃ | CH₂CH₃ | CH₃ | CH₂CH₃ | OCH₃ |
| II-20 | CH₃ | CH(CH₃)₂ | CH₃ | CH(CH₃)₂ | OCH₃ |
| II-21 | CH₃ | CH₂CH═CH₂ | CH₃ | CH₂CH═CH₂ | OCH₃ |
| II-22 | CF₃ | H | CF₃ | H | OCH₃ |
| II-23 | CF₃ | CH₃ | CF₃ | CH₃ | OCH₃ |
| II-24 | CN | H | CH₃ | H | OCH₃ |
| II-25 | CN | CH₃ | CH₃ | CH₃ | OCH₃ |

Further especially preferred active ingredients (a), in addition to the strobilurins which have been mentioned as preferred or especially preferred, are the following compounds: pyroquilon, tricyclazol, isoprothiolane, edifenphos, ferimzone, fludioxinil, pencycuron, flutolanil, mepronil, thifluzamid, iprodione and furametpyr.

Active ingredient (b) is at least one active ingredient selected from the class of the herbicides, insecticides and/or growth regulators. Thus, combinations of the active ingredients (a) and (b) are also in accordance with the invention.

The following list of insecticides identifies possible active ingredients, but is not understood as being limited thereto.

Neonicotinoids/chloronicotinyl compounds, such as imidacloprid, acetamiprid, nitenpyram, thiacloprid, thiamethoxam, MIT-446 (terafuranitdine);

pyrroles, such as chlorphenapyr, fludioxonil;

organophosphates, such as acephate, azinphos-methyl, chlorpyrifos, dimethoate, disulfoton fosthiazate, methamidophos, methidathion, methyl-parathion, oxydemeton-methyl, phorate, phosalone, phosmet, profenofos, trichlorfon, malathion, phosphamidon, monocrotophos, fenitrothion, diazinon, EPN;

carbamates, such as alanycarb, aldicarb, benfuracarb, carbofuran, carbosulfan, furathiocarb, methomyl, oxamyl, pirimicarb, thiodicarb, fenobucarb;

pyrethroids, such as bifenthrin, cyfluthrin, cypermethrin, deltamethrin, ethofenprox, esfenvalerate, fenpropathrin, flucythrinate, fluvalinate, lambda-cyhalothrin, permethrin, pyrethrin I, pyrethrin II, silafluofen, tau-fluvalinate, tralomethrin, alpha-cypermethrin, zeta-cypermethrin;

urea derivatives, such as diflubenzuron, flucycloxuron, flufenoxuron, hexaflumuron, lufenuron, novaluron, triflumuron;

juvenuids, such as buprofezin, diofenolan, fenoxycarb, pyriproxifen, methoxyfenozide, tebufenozide;

various, such as abamectin, spinosad, amitraz, cartap, chlorfenapyr, diafenthiuron, fipronil, imidacloprid, pyridaben, tebufenpyrad, nidinotefuran (MTI-446), fenazaquin, fenpyroxymate, thiocyclam, silafluofen, nidinotefuran (MTI-446) and clothionidin ((E)-1-(2-chlorothiazol-5-ylmethyl)-3-methyl-2-nitroguanidine (TI-435).

The following insecticides may be mentioned as being preferred:

imidacloprid, acetamiprid, nitenpyram, fipronil, carbofuran, carbosulfan, benfuracarb, thiacloprid, fludioxonil, nidinotefuran (MTI-446), thiamethoxam, clothionidin, terfuranitdine.

Especially preferred insecticides are nidinotefuran (MTI-446), fipronil, thiacloprid, imidacloprid and clothionidin.

The following list of herbicides identifies possible active ingredients, but is not understood as being limited thereto.

1,3,4-thiadiazoles, such as buthidazole, cyprazole;,

amides, such as allidochlor (CDAA), benzoylprop-ethyl, bromobutide, chlorthiamid, dimepiperate, dimethenamid, s-dimethenamid, diphenamid, etobenzanid (benzchlomet), flamprop-methyl, fluthiamide, fosamin, isoxaben, monalide, naptalame, pronamid (propyzamid), propanil; aminophosphoric acids, such as bilanafos, (bialaphos), buminafos, glufosinate-ammonium, glyphosate, sulfosate;

aminotriazoles, such as amitrole, anilides (such as anilofos, mefenacet), aryloxyalkanoic acids (such as 2,4-D, 2,4-DB, clomeprop, dichlorprop, dichlorprop-p, dichlorprop-p (2,4-DP-P), fenoprop (2,4,5-TP), fluoroxypyr, MCPA, MCPB, mecoprop, mecoprop-P, napropamide, napropanilide, triclopyr, N-(1-cyano-1,2-dimethylpropyl)-2-(2,4-dichlorophenoxy)propion-amide;

benzoic acids, such as chloramben, dicamba; benzothiadiazinones, such as bentazone;

bleaches, such as clomazone (dimethazone), diflufenican, fluorochloridone, flupoxam, fluridone, pyrazolate, sulcotrione (chlormesulone), isoxaflutole, isoxachlortole, mesotrione), carbamates (such as asulam, barban, butylate, carbetamid, chlorbufam, chlorpropham, cycloate, desmedipham, di-allate, EPTC, esprocarb, molinate, orbencarb, pebulate, phenisopham, phenmedipham, propham, prosulfocarb, pyributicarb, sulf-allate (CDEC), terbucarb, thiobencarb (benthiocarb), tiocarbazil, tri-allate, vernolate;

quinolinecarboxylic acids, such as quinclorac, quinmerac;

chloroacetanilides, such as acetochlor, alachlor, butachlor, butenachlor, diethatyl-ethyl, dimethachlor, metazachlor, metolachlor, pretilachlor, propachlor, prynachlor, terbuchlor, thenylchlor, xylachlor, s-metolachlor;

cyclohexenones, such as alloxydim, tepraloxydim, clethodim, cloproxydim, cycloxydim, sethoxydim, tralkoxydim, 2-{1-[2-(4-chlorophenoxy)propyloxyimino]butyl}-3-hydroxy-5-(2H-tetrahydrothiopyran-3-yl)-2-cyclohexen-1-one, butroxydim, clefoxydim;

dichloropropionic acids, such as dalapon;

dihydrobenzofurans, such as ethofumesate;

dihydrofuran-3-ones, such as flurtamone;

dinitroanilines, such as benefin, butralin, dinitramin, ethalfluralin, fluchloralin, isopropalin, nitralin, oryzalin, pendimethalin, prodiamine, profluralin, trifluralin; dinitrophenols, such as bromofenoxim, dinoseb, dinoseb-acetate, dinoterb, DNOC;

diphenyl ethers, such as acifluorfen-sodium, aclonifen, bifenox, chlornitrofen (CNP), difenoxuron, ethoxyfen, fluorodifen, fluoroglycofen-ethyl, fomesafen, furyloxyfen, lactofen, nitrofen, nitrofluorfen, oxyfluorfen;

dipyridylenes; such as cyperquat, difenzoquat-methylsulfate, diquat, paraquatdichloride;

ureas, such as benzthiazuron, buturon, chlorbromuron, chloroxuron, chlortoluron, cumyluron, dibenzyluron, cycluron, dimefuron, diuron, dymron, ethidimuron, fenuron, fluometuron, isoproturon, isouron, karbutilate, linuron, methabenzthiazuron, metobenzuron, metoxuron, monolinuron, monuron, neburon, siduron, tebuthiuron, trimeturon;

imidazoles, such as isocarbamid;

imidazolinones, such as imazamethapyr, imazapyr, imazaquin, imazethabenz-methyl (imazame), imazethapyr, imazapic;

oxadiazoles, such as methazole, oxadiargyl, oxadiazon;

oxiranes, such as tridiphane;

phenols, such as bromoxynil, ioxynil;

phenoxyphenoxypropionic esters, such as clodinafop, cloquintocet, cyhalofop-butyl, diclofop-methyl, fenoxaprop-ethyl, fenoxaprop-p-ethyl, fenthiapropethyl, fluazifop-butyl, fluazifop-p-butyl, haloxyfop-ethoxyethyl, haloxyfop-methyl, haloxyfop-p-methyl, isoxapyrifop, propaquizafop, quizalofop-ethyl, quizalofop-p-ethyl, quizalofop-tefuryl;

phenylacetic acids, such as chlorfenac (fenac);

phenylpropionic acids, such as chlorophenprop-methyl;

protoporphyrinogen IX oxidase inhibitors, such as benzofenap, cinidon-ethyl, flumiclorac-pentyl, flumioxazin, flumipropyn, flupropacil, fluthiacet-methyl, pyrazoxyfen, sulfentrazone, thidiazimin, carfentrazone;

pyrazoles, such as nipyraclofen, ET 751;

pyridazines, such as chloridazon, maleic hydrazide, norflurazon, yridate;

pyridinecarboxylic acids, such as clopyralid, dithiopyr, picloram, thiazopyr, diflufenzopyr;

pyrimidyl ethers, such as pyrithiobac acid, pyrithiobac-sodium, KIH-2023, KIH-6127, pyribenzoxym;

sulfonamides, such as flumetsulam, metosulam;

sulfonylureas; such as amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, halosulfuron-methyl, imazosulfuron, metsulfuron-methyl, nicosulfuron, primisulfuron, prosulfuron, pyrazosulfuron-ethyl, rimsulfuron, sulfometuron-methyl, thifensulfuron-methyl, triasulfuron, tribenuron-methyl, triflusulfuron-methyl, N-[[[4-methoxy-6-(trifluoromethyl)-1,3,5-triazin-2-yl]amino]-carbonyl]-2-(trifluormethyl) benzenesulfonamide, sulfosulfuron, idosulfuron;

triazines, such as ametryn, atrazine, aziprotryn, cyanazine, cyprazine, desmetryn, dimethamethryn, dipropetryn, eglinazine-ethyl, hexazinone, procyazine, prometon, prometryn, propazine, secbumeton, simazine, simetryn, terbumeton, terbutryn, terbutylazine, trietazine;

triazinones, such as ethiozin, metamitron, metribuzin;

triazolecarboxamides, such as triazofenamid;

uracils, such as bromacil, lenacil, terbacil;

various herbicides, such as benazolin, benfuresate, bensulide, benzofluor, butamifos, cafenstrole, chlorthal-dimethyl (DCPA), cinmethylin, dichlobenil, endothall, fluorbentranil, mefluidide, perfluidone, piperophos, flucabazone, oxaciclomefone (MY 100);

The following list of compounds with growth regulatory action identifies possible active ingredients, but is not intended to be restricted thereto:

1-naphthylacetamide, 1-naphthylacetic acid, 2-naphthyloxyacetic acid, 3-CPA, 4-CPA, ancymidol, anthraquinone, BAP, butifos; tribufos, butralin, chlorflurenol, chlormequat, clofencet, cyclanilide, daminozide, dicamba, dikegulac-sodium, dimethipin, chlorfenethol, etacelasil, ethephon, ethychlozate, fenoprop, 2,4,5-TP, fluoridamid, flurprimidol, flutriafol, gibberellic acid, gibberellin, guazatine, imazalil, indolylbutyric acid, indolylacetic acid, karetazan, kinetin, lactidichlor-ethyl, maleic hydrazide, mefluidide, mepiquat-chloride, naptalam, paclobutrazole, prohexadione-calcium, quinmerac, sintofen, tetcyclacis, thidiazuron, triiodobenzoic acid, triapenthenol, triazethan, tribufos, trinexapac-ethyl, uniconazole.

Examples of suitable polymeric binders (d) are:

polyolefins, such as polyethylene, polypropylene, polybutylene and polyisobutinylylene; vinyl polymers such as polyvinyl chloride, polyvinylpyrrolidone, polyvinylinylcaprolactamcropolactouran, polyvinyl acetate, polystyrene, polyacrylonitrile, polyacrylates, polymethacrylates; polyacetals such as polyoxymethylene; polyesters with at least part-aliphatic ester groups such as polyhydroxybutyric acid, polyhydroxyvaleric acid, polybutylene succinates, polyalkylene terephthalates such as polyalkylene adipate terephthalates such as polybutylene adipate terephthalates; polyester amides; polyether amides; polyamides; polyester amides; polycaprolactams; polyimides; polyethers; polyether ketones; polyurethanes and polycarbonates; copolymers of ethylene/vinyl acetate, ethylene/(meth)acrylates, styrene/acrylonitrile, styrene/butadiene, styrene/butadiene/acrylonitrile, olefin/maleic anhydride; collagen, gelatin, cellulose and cellulose derivatives, starch and its derivatives.

Examples of preferred polymers are polyolefins, such as polyethylene, polypropylene and biodegradable polyesters such as polybutylene succinates; polyhydroxybutyric acid; polyhydroxyvaleric acid; polyalkylene terephthalates such as polyalkylene adipate terephthalates such as polybutylene adipate terephthalates; polyamides, polyester amides, polycaprolactams, and collagen, gelatin, cellulose and cellulose derivatives, starch and its derivatives.

Especially preferred are biodegradable polybutylene adipate terephthalates, as are described, for example, in DE-A 4440858, which is herewith incorporated by reference. An especially preferred polybutylene adipate terephthalate is commercially available under the trade name Ecoflex®(BASF).

The amount of the thermoplastic water-insoluble polymer (d) in the total formulation can vary, depending on the activity, release rate and processability. In general, the amount ranges from 0-80% by weight, preferably 5-60% by weight and especially preferably 15-50% by weight, based on the total formulation, under the condition that the formulation can still be subjected to thermoplastic processing.

Suitable mineral fillers (e) are those which, owing to their density, improve or make possible the sedimentation of the granules in the aqueous medium, which can be incorporated in high quantities into thermoplastic polymers, which are not unduly hard, i.e. are capable of processing in the extruder, which are chemically indifferent, which increase the heat resistance of the formulation, are thermally stable themselves, improve the granulation properties of the melt, which make possible the release of the active ingredient, and which are environmentally friendly and, moreover, as inexpensive as possible. Moreover, the incorporability of components with low viscosity, such as, for example, the active ingredient, is improved. The type and amount of filler additionally affect the release of the active ingredient(s) from the polymer matrix.

Addition of the fillers leads to better sedimentation (high density of the mineral), granulation properties and an increase in heat resistance.

Examples of suitable mineral fillers (e) are: oxides, hydroxides, silicates, carbonates and sulfates of calcium, magnesium, aluminum and titanium; in individual cases for example chalk, gypsum, bentonite, kaolin, wollastonite, talc, phlogopite, clay minerals-in general, and mixtures of a variety of mineral fillers.

Preferred mineral fillers (e) are, for example, lime (calcium carbonate), gypsum (calcium sulfate) and talc (magnesium silicate), which can be used particularly well owing to their low hardness and their lubrication properties.

The amount of mineral filler (e) may vary within wide limits, depending on the granulation properties and the processability. Thus, the filler content may range from 10-80% by weight, preferably from 20-70% by weight and especially preferably from 30-60% by weight, based on the total formulation. The only condition is that the formulation can still be subjected to thermoplastic processing.

In addition, inorganic or organic additives (f) are optionally used to improve the processability of the mixture and to modulate release of the active ingredient(s). The amount of the additives (f) should range from 0-20% by weight, preferably from 0-10% by weight, and especially preferably from 0-5% by weight, based on the total formulation. The only condition is that the formulation can still be subjected to thermoplastic processing.

The group of the additives (f) can be divided as follows:

1) auxiliaries conventionally used in extrusion technology, such as lubricants, mold release agents, fluidization auxiliaries, plasticizers and stabilizers, as are described, for example, in DE-A 19504832, which is herewith incorporated by reference;

2) additives which affect release of the active ingredient(s):

water-soluble inorganic substances such as, for example,. sodium chloride, sodium sulfate or calcium sulfate

water-soluble organic substances such as, for example, neopentyl glycol, polyethylene glycol or urea

nonionic or ionic surfactants such as, for example, fatty alcohol ethoxylates, alkylbenzenesulfonates or alkylnaphthalenesulfonates

waxes, fatty alcohols and fatty acids, fats and oils, such as, for example, carnauba wax, stearic acid, stearyl alcohol or castor oil.

To prepare the formulations in accordance with the method of the invention, all components can either be molten together directly in the form of a physical mixture or mixed with the pre-formed polymer melt. In general, it is customary to meter into the extruder a physical mixture of active ingredient (a), active ingredient (b), polymer (c), polymer (d), filler (e) and additive (f) jointly in a free feed, for example via a differential weigh feeder, where it is molten.

The process steps of mixing and melting can be carried out in the customary manner, for example as described in EP-A 240904, EP-A 337256 and EP-A 358195.

In general, the components are mixed in the melt in a manner known per se in kneaders or extruders, preferably in single- or twin-screw extruders, in a temperature range between 50 and 200° C., preferably between 50 and 150° C., and especially preferably in a temperature range of between 50 and 140° C.

The extruder may contain mixing, kneading and return elements, as required. If appropriate, existing solvents and residual moisture may be stripped off during the extrusion by means of gas outlet ports or vacuum pumps. Moreover, components in liquid or else in solid form can be introduced via pumps or conveying means arranged laterally. The extrusion device used depends on the desired shape.

The melt which exits may be shaped by extrusion granulation of the fully or partially cooled extrudates, by hot cutting of the melt at the extruder head using a cut-off unit with rotating knives, by underwater granulation directly at the exit point of the melt from the nozzle, or by another method conventionally used in plastics technology as described, inter alia, in EP-A 240906 and DE-A 3 830 355. The resulting solid shapes can be processed further to give shaped articles, for example by injection molding.

In a preferred embodiment, the melt which exits is shaped by extrusion granulation.

Moreover, a layered structure can be realized by coextrusion or subsequent coating, for example in a fluidized bed, with the aid of solutions or dispersions which may or may not comprise active ingredient and polymer, and this layered structure modifies the release of the shaped article according to the invention. Moreover, active ingredient (b) or a further active ingredient from the same class as active ingredient (b) can be applied in this manner to the prepared granules.

The formulations prepared via one of the methods according to the invention are also a subject matter of the present invention.

The formulations prepared by the method according to the invention are suitable for controlling phytopathogenic fungi, undesired plant growth, undesired attack by insects and/or for regulating the growth of plants. The present invention therefore relates to a method of controlling phytopathogenic fungi, undesired plant growth, undesired attack by insects or mites and/or for regulating the growth of plants, which comprises allowing a solid crop protection composition formulation according to the invention prepared by the method according to the invention to act on plants, their environment or on seed.

Phytopathogenic fungi which can be controlled by formulations according to the invention are understood as meaning, for example, the following species:

Alternaria species, Podosphaera species, Sclerotinia species, Physalospora canker on vegetables and fruit, Botrytis cinerea (gray mold) on strawberries, vegetables, ornamentals and grapevines, Corynespora melonis on cucumbers, strawberries; Colletotrichum species on cucumbers; Diplocarpon rosae on roses; Elsinoe fawcetti and Diaporthe citri on citrus fruit; Sphaerotheca species on cucumbers, cucurbits, strawberries and roses; Cercospora species on peanuts, sugar beet, eggplant and date-plums; Erysiphe cichoracearum and Sphaerotheca fuliginea on cucurbits, Leveiillina taurica on pimento; Mycosphaerella species on apples and Japanese apricot; Phyllactinia kakicola, Gloesporium kaki on Japanese apricot; Gymnosporangium yamadae, Leptotthrydium pomi, Podosphaera leucotricha and Gloedes pomigena on apples; Cladosporium carpophilum on pears and Japanese apricot; Phomopsis species on pears; Phytopora species on citrus fruit, potatoes, onions; Phytophthora infestans on potatoes and tomatoes, Erysiphe graminis (powdery mildew) on cereals, Fusarium- and Verticillium species on a variety of plants, Glomerella cingulata on tea; Helminthosporium species on cereals, Mycosphaerella species on bananas and peanuts, Plasmopara viticola on grapevines and grapefruits, Personospora species on onions, spinach and chrysanthemums; Phaeoisariopsis vitis and Spaceloma ampelina on grapefruits; Pseudocercosporella herpotrichoides on wheat and barley, Pseudoperonospora species on hops and cucumbers, Puccinia species and Typhula species on cereals, Pyricularia oryzae on rice, Rhizoctonia species on cotton, rice and turf, Septoria nodorum on wheat, Uncinula necator on grapevines, Ustilago species on cereals and sugar cane, and Venturia species (scab) on apples and pears.

Insects which can be controlled by the formulations according to the invention are understood as meaning, for example, the following animal pests:

from the order Lepidoptera (butterflies and moths), for example, Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exiqua, Leucoptera coffeella, Leucoptera scitella, Lithotis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

from the order Coleoptera (beetles), for example, Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria,

from the order of the Diptera (dipterans), for example, Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia irritans, Haplodiplosis equestris, Hylemyia platura, Hypoderma lineata, Liriomyza sativae, Liriomyza trifolii, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa,

from the order Thysanoptera , for example, Frankliniella fusca, Frankliniella occidentalis, Frankliniella tritici, Scirtothrips citri, Thrips oryzae, Thrips palmi and Thrips tabaci,

from the order Hymenoptera , for example, Athalia rosae, Atta cephalotes, Atta sexdens, Atta texana, Hoplocampa minuta, Hoplocampa testudinea, Monomorium pharaonis, Solenopsis geminata and Solenopsis invicta,

from the order Heteroptera , for example, Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis and Thyanta perditor,

from the order Homoptera , for example, Acyrthosiphon onobrychis, Adelges laricis, Aphidula nasturtii, Aphis fabae, Aphis pomi, Aphis sambuci, Brachycaudus cardui, Brevicoryne brassicae, Cerosipha gossypii, Dreyfusia nordmannianae, Dreyfusia piceae, Dysaphis radicola, Dysaulacorthum pseudosolani, Empoasca fabae, Macrosiphum avenae, Macrosiphum euphorbiae, Macrosiphon rosae, Megoura viciae, Metopolophium dirhodum, Myzodes persicae, Myzus cerasi, Nilaparvata lugens, Pemphigus bursarius, Perkinsiella saccharicida, Phorodon humuli, Psylla mali, Psylla piri, Rhopalomyzus ascalonicus, Rhopalosiphum maidis, Sappaphis mala, Sappaphis mali, Schizaphis graminum, Schizoneura lanuginosa, trialeurodes vaporariorum and Viteus vitifolii,

from the order Isoptera , for example, Calotermes flavicollis, Leucotermes flavipes, Reticulitermes lucifugus and Termes natalensis,

from the order Orthoptera, for example, Acheta domestica, Blatta orientalis, Blattella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus,

from the order Acari , for example, Amblyomma americanum, Amblyomma variegatum, Argas persicus, Boophilus annulatus, Boophilus decoloratus, Boophilus microplus, Brevipalpus phoenicis, Bryobia praetiosa, Dermacentor silvarum, Eotetranychus carpini, Eriophyes sheldoni, Hyalomma truncatum, Ixodes ricinus, Ixodes rubicundus, Ornithodorus moubata, Otobius megnini, Paratetranychus pilosus, Dermanyssus gallinae, Phyllocoptruta oleivora, polyphagotarsonemus latus, Psoroptes ovis, Rhipicephalus appendiculatus, Rhipicephalus evertsi, Sarcoptes scabiei, Tetranychus cinnabarinus, Tetranychus kanzawai, Tetranychus pacificus, Tetranychus telarius and Tetranychus urticae,

from the order of the nematodes such as root-knot nematodes, for example, Meloidogyne hapla, Meloidogyne incognita, Meloidogyne javanica, cyst nematodes , for example, Globodera rostochiensis, heterodera avenae, heterodera glycines, heterodera schachtii, heterodera trifolii, stem earworms and foliar nematodes, for example, Belonolaimus longicaudatus, Ditylenchus destructor, Ditylenchus dipsaci, Heliocotylenchus multicinctus, Longidorus elongatus, Radopholus similis, Rotylenchus robustus, Trichodorus primitivus, Tylenchorhynchus claytoni, Tylenchorhynchus dubius, Pratylenchus neglectus, Pratylenchus penetrans, Pratylenchus curvitatus and Pratylenchus goodeyi.

The control of undesired vegetation is understood as meaning the destruction of weeds. Weeds, in the broadest sense, are understood as meaning all those plants which grow in locations where they are undesired, for example:

dicotyledonous weeds of the genera: Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum.

Monocotyledonous weeds of the genera: Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristyslis, Sagittaria, Eleocharis, Scirpus, Paspalum, Ischaemum, Sphenoclea, Dactyloctenium, Agrostis, Alopecurus, Apera.

Moreover, the formulations according to the invention can be employed in a further number of crop plants for eliminating undesired plants. Suitable crops are, for example, the following:

Allium cepa, Ananas comosus, Arachis hypogaea, Asparagus officinalis, Beta vulgaris spec. altissima, Beta vulgaris spec. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pisum sativum, Prunus avium, Prunus persica, Pyrus communis, Ribes sylestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera, Zea mays.

The growth of plants can be regulated by the growth regulators which have already been mentioned further above or by employing fertilizers.

In a preferred embodiment of the abovementioned method, the formulations prepared in accordance with the method according to the invention are used to control phytopathogenic fungi and undesired attack by insects.

The formulations according to the invention can be applied pre or post-emergence. If the herbicidal active ingredients are less well tolerated by specific crop plants, application techniques may be employed in which the spray mixtures prepared from the formulations according to the invention are sprayed, with the aid of the spraying apparatus, in such a way that they come into as little contact as possible, if any, with the leaves of the sensitive crop plants, whereby the active ingredients reach the leaves of undesired plants which grow underneath them, or the bare soil surface (post-directed, lay-by).

Depending on the intended aim of the control measures, the season, the target plants and the growth stage, the application rates of active ingredient amount to from 0.001 to 3.0, preferably from 0.01 to 1.0 kg/ha.

In an especially preferred embodiment of the abovementioned method, a solid crop protection composition formulation prepared in accordance with the method according to the invention is applied, in the form of spreadable granules, to soils which are permanently or temporarily flooded. In this context, the granules may also be introduced directly into the boxes which accommodate the plant seed for sowing, so that, when the boxes are introduced into the water, fungal infection, undesired plant growth, and undesired attack by insects or mites can be avoided and/or the growth of the plants regulated in a preventative fashion.

In a preferred embodiment of the abovementioned method, the formulations prepared in accordance with the method according to the invention are used [lacuna] phytopathogenic fungi and undesired attack by insects.

The method according to the invention will be illustrated hereinbelow with the aid of examples:

### EXAMPLE 1

A) General Procedure

The amounts of active ingredient (a), active ingredient (b), polymer (c), polymer (d), filler (e) and additive (f), all of which are stated in the examples, were mixed and, using a proportioning weigher, introduced into the conveying zone (zone 1) of a closely intermeshing counterrotating twin-screw extruder (twin-shaft screw kneader by Werner & Pfleiderer) and plasticized or homogenized carefully at a screw speed of 150 rpm and a throughput of 3 to 4 kg/h. The melt was discharged at the extruder head via a 5-hole nozzle of diameter 2 mm each and applied directly to a conveyor belt. With the aid of this metal conveyor belt, the 5 extrudates, depending on their degree of cooling, were additionally, via an air-cooled guide chute, either wound onto a conveying drum (Haake) and subjected to manual follow-up granulation, or else fed directly “on-line” to the extrusion granulator (type SGS 100/E , C.F. Scheer & CIE) and formulated into cylindrical granules 1.1 mm in length and with an average cross section of 1.0-1.2 mm. The extrudates processed “on-line” were conditioned directly in the granulator with cooled pressurized air (specialist dry-ice cooler).

The temperature course in the extruder (zones 1-10) and the granulator of the examples which follow can be seen from table 1:

TABLE 1

| | Zone | | | | | | | | | | |
|---|---|---|---|---|---|---|---|---|---|---|---|
| | 1 | 2 | 3 | 4 | 5 | 6 | 7 | 8 | 9 | 10 | Granulator |
| T in [° C.] | 80 | 120 | 150 | 150 | 150 | 151 | 140 | 130 | 130 | 150 | −30 |

### EXAMPLE 2

Preparation of the Formulations

The following starting materials were used:

Active ingredient (a):

N-Methyl-2-(methoxyimino)-2-{2-[(3E,6E)-5-(methoxyimino)-4,6-dimethyl-2,8-dioxa-3,7-diazanona-3,6-dien-1-yl]phenyl}-acetamide [II-4]; solubility in water=0.08 g/l, melting point=100° C.

Active ingredient (b):

I: Clothianidin

solubility in water=0.27 g/l, melting point=176-178° C.; (TI-435, Takeda, Japan)

II: 1-Methyl-2-nitro-3-[tetrahydrofuryl)methyl]guanidine;

solubility in water=54 g/l, melting point=94.5-101.5° C.; (MTI-446, Mitsui Chemicals, Japan)

Polymer (c):

Polylactide (Lactea [M=118 000 g/mol, Mitsui Chemicals, Japan)

Polymer (d):

Polybutylene adipate terephthalate (Ecoflex, BASF AG, DE)

Filler (e):

Calcium carbonate (Merck, DE)

Table 2 shows the percentage ratio of the formulations prepared in the above-described manner. The data are given as percent by weight.

Formulations 1, 2 and 7 cannot be granulated in the above-described manner since the extrudates, which are still elastic, are extended upon cutting. This gives very inhomogeneous granules, the throughput being approximately 0.3 kg/h per hole.

Formulations 3-6 and 8 can be granulated in the above-described manner without problems. They give homogeneous granules with a throughput of 4 kg/h per hole.

Formulation 8 is particularly noticeable, since active ingredient b(II) is freely soluble in water: formulations in which the active ingredient would come into contact with water too soon would not be suitable in this case.

TABLE 2

| | | b | b | | | |
|---|---|---|---|---|---|---|
| No.\Component | a | (I) | (II) | c | d | e |
| 1 | 7 | — | — | — | 43 | 50 |
| 2 | 7 | 1.5 | — | — | 41.5 | 50 |
| 3 | 7 | — | — | 10 | 33 | 50 |
| 4 | 7 | — | — | 15 | 28 | 50 |
| 5 | 7 | — | — | 20 | 23 | 50 |
| 6 | 7 | 1.5 | — | 20 | 22.5 | 50 |
| 7 | 7 | — | 2 | — | 41 | 50 |
| 8 | 7 | — | 2 | 20 | 21 | 50 |

### EXAMPLE 3

The granules obtained were tested for sedimentation in water. To this end, 1 g of granules were added to 1 l of drinking water at 20° C. and subjected to vibration-proof storage for 48 hours. All of the formulations sediment in water.

Moreover, the storage stability of the resulting granules was tested. 50 g of granules were stored for 14 days in sealed 100 ml containers in a drying oven at 54° C. After heat-aging, the granules remained dimensionally stable and flowable, i.e. no tendency to agglomerate was observed.

### EXAMPLE 4

A UV/VIS spectrometer (model HP 8452, Diode Array Spectrophotometer) and a 1 cm quartz cuvette were used to determine the active ingredients. Depending on the absorption maximum of the active ingredient in question, the measurements were carried out in the wavelength range λ=250 nm.

At the beginning of the experiment, calibration curves (absorption vs. concentration) were established of all of the active ingredients.

To determine the release of active ingredient, 1 g of granules of each of the formulations 1-8 was introduced into a 1 l gradiated flask and covered with 1 l of drinking water. The gradiated flasks were stored for at least 4 weeks at 25° C. under vibration-proof conditions. To determine the release of active ingredient, samples were taken daily. Prior to sampling, the gradiated flask was turned by 180° C. and mixed to ensure homogeneous distribution of the active ingredient. The aqueous solutions were subsequently measured in the UV/VIS spectrometer and returned into the flasks.

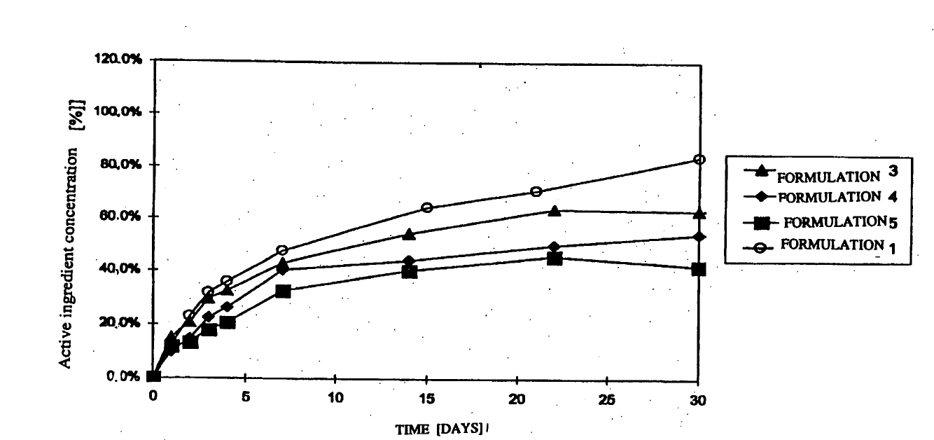

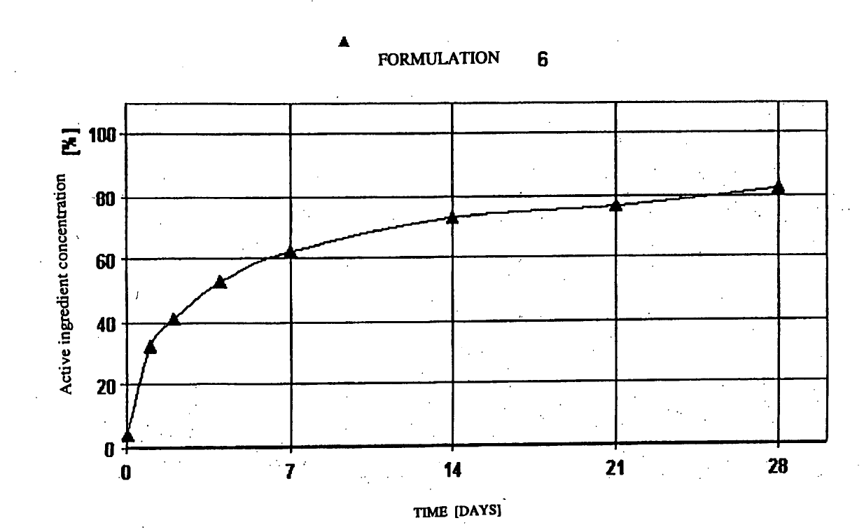

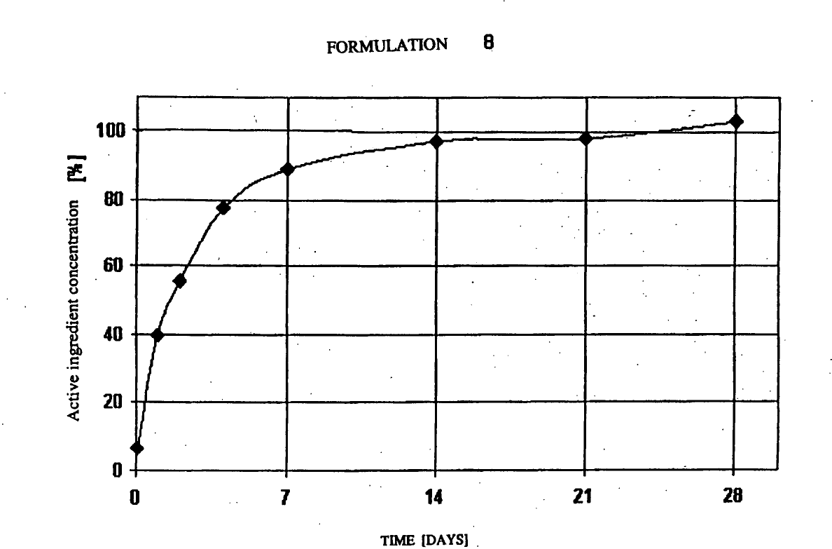

The release rates of the active ingredient(s) in question are shown in FIG. 1. Here, the percentage release (100% corresponding to the complete release of 50 ppm of active ingredient of 1 g 5% formulation in 1 l of water) was plotted versus the time in days (see FIGS. 1-3).

The cumulative release of the active ingredients is square-root-dependent, as would be expected-for a diffusion process ((t)^{-1/2} law):

c=K×(t)^{-1/2} (t: time, c: active ingredient concentration)

As can be seen from FIGS. 1-3, the release rate depends on the composition of the polymer matrix: the release rate can be slowed down in a controlled fashion with increasing amounts of polymer (c).

1. A method for the preparation of a solid formulation of a slow-release crop protection product, which comprises carrying out a melt extrusion of a composition comprising
(a) 0.1 to 80% by weight of at least one fungicidal active ingredient;
(b) 0 to 80% by weight of at least one herbicidal, acaricidal, insecticidal or growth-regulatory active ingredient;
(c) 3 to 80% by weight of a thermoplastic, water-insoluble polymer from the group of the polylactides;
(d) 5 to 80% by weight of at least one polybutylene adipate terephthalate;
(e) 10 to 80% by weight of at least one mineral filler; and
(f) 0 to 20% by weight of inorganic or organic additives; the total of components (a) to (f) being 100%, and subsequently shaping the extrudate.

2. A method as claimed in claim 1, wherein the composition comprises 5 to 6% by weight of component (d).

3. A method as claimed in claim 1 wherein a fungicidal active ingredient selected from the group consisting of pyroquilon, tricyclazol, isoprothiolane, edifenphos, ferimzone, fludioxinil, pencycuron, flutolanil, mepronil, thifluzamid, iprodione, furametpyr and/or from the class of the strobilurins is used as component (a).

4. A method as claimed in claim 3, wherein a strobilurin of the formula I 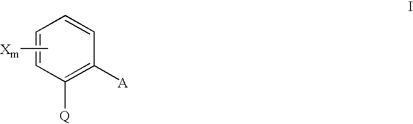
in which
X is halogen, C₁₋, C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃ or N(—OCH₃)—COOCH₃;
A is —O—B, —CH₂O—B, —OCH₂—B, —CH═CH—B, —C═C—B, —CH₂O—N═C(R¹)—B or —CH₂O—N═C(R¹)—C(R²)═N—OR³, where
B is phenyl, naphthyl, 5-membered or 6-membered hetaryl or 5-membered or 6-membered heterocyclyl, comprising one to three N atoms and/or one O or S atom or one or two O and/or S atoms, the ring systems being unsubstituted or substituted by one to three radicals R^{a}:
R^{a} is cyano, nitro, amino, aminocarbonyl, aminothiocarbonyl, halogen, C₁₋C₆-alkyl, C₁₋C₆-halo-alkyl, C₁₋C₆-alkylcarbonyl, C₁₋C₆-alkylsulfonyl, C₁₋C₆-alkylsulfoxyl, C₁₋-C₆cycloalkyl, C₁₋C₆-alkoxy,C₁₋-C₆-haloalkoxy,C₁₋alkyloxycarbonyl, C₁₋C₆-akylthio, C₁₋C₆-alkylamino, di-C₁₋C₆-alkylamino, C₁₋C₆-alkylaminocarbonyl, di-C₁₋C₆-alkylaminocarbonyl, C₁₋C₆-alkylaminothiocarbonyl, di-C₁₋-C₆-alkylaminothiocarbonyl, C₂₋-C₆-alkenyl, C₂₋-C₆-alkenyloxy, phenyl, phenoxy, benzyl, benzyloxy, 5- or 6-membered heterocyclyl, 5- or 6-membered hetaryl, 5- or 6-membered hetaryloxy, CR^{α})═NOR^{β} or OC(R^{α})₂₋C(R^{β})═NOR^{β}, the cyclic radicals, in turn, being unsubstituted or substituted by one to three radicals R^{b}:
R^{b} is cyano, nitro, halogen, amino, aminocarbonyl, aminothiocarbonyl, C₁₋C₆-alkyl, C₁₋C₆-haloalkyl, C₁₋C₆-alkylsulfonyl, C₁₋C₆-alkylsulfoxyl, C₃₋C₆₋-cycloalkyl, C₁₋C₆-alkoxy, C₁₋C₆-haloalkoxy, C₁₋C₆-alkoxycarbonyl, C₁₋C₆-alkylthio, C₁₋C₆-alkylamino, di-C₁₋C₆-alkylamino, C₁₋C₆-alkylaminocarbonyl, di-C₁₋C₆-alkylaminocarbonyl, C₁₋C₆-alkylaminothiocarbonyl, di-C₁₋C₆-alkylaminothio-carbonyl, C₂₋C₆-alkenyl, C₂₋C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered hetaryl, 5- or 6-membered hetaryloxy or C(R^{α})═NOR^{β};
R^{α}, R^{β} are hydrogen or C₁₋C₆-alkyl;
R¹ is hydrogen, cyano, C₁₋C₄-alkyl, C₁₋C₄-haloalkyl, C₃₋C₆₋cycloalkyl, C₁₋C₄-alkoxy;
R² is phenyl, phenylcarbonyl, phenylsulfonyl, 5- or 6-membered hetaryl, 5- or 6-membered hetarylcarbonyl or 5- or 6-membered hetarylsulfonyl, the ring systems being unsubstituted or substituted by one to three radicals R^{a}; C₁₋C₁₀-alkyl, C₃₋C₆₋cycloalkyl, C₂₋C₁₀-alkenyl, C₂₋C₁₀-alkynyl, C₁₋C₁₀-alkylcarbonyl, C₂₋C₁₀-alkenylcarbonyl, C₃₋C₁₀-alkynylcarbonyl, C₁₋C₁₀-alkylsulfonyl, or C(R^{α})═NOR^{β}, the hydrocarbon radicals of these groups being unsubstituted or substituted by one to three radicals R^{c}:
R^{c} is cyano, nitro, amino, aminocarbonyl, aminothiocarbonyl, halogen, C₁₋C₆-alkyl, C₁₋C₆-haloalkyl, C₁₋C₆-alkylsulfonyl, C₁₋C₆-alkylsulfoxyl, C₁₋C₆-alkoxy, C₁₋C₆-haloalkoxy, C₁₋C₆-alkoxycarbonyl, C₁₋C₆-alkylthio, C₁₋C₆-alkylamino, di-C₁₋C₆-alkylamino, C₁₋C₆-alkylaminocarbonyl, di-C₁₋C₆-alkylaminocarbonyl, C₁₋C₆-alkylaminothiocarbonyl, di-C₁₋C₆-alkylaminothiocarbonyl, C₂₋C₆-alkenyl, C₂₋C₆-alkenyloxy, C₃₋C₆-cycloalkyl, C₃₋C₆₋cycloalkyloxy, 5- or 6-membered heterocyclyl, 5- or 6-membered heterocyclyloxy, benzyl, benzyloxy, phenyl, phenoxy, phenylthio, 5- or 6-membered hetaryl, 5- or 6-membered hetaryloxy and hetarylthio, it being possible for the cyclic groups, in turn, to be partially or fully halogenated or to have attached to them one to three radicals R^{a}; and
R³ is hydrogen,
C₁₋C₆-alkyl, C₂₋C₆-alkenyl, C₂₋C₆-alkynyl, the hydrocarbon radicals of these groups being unsubstituted or substituted by one to three groups R^{c} which can optionally be substituted by one to three radicals R^{a};
is used as component (a).

5. A method as claimed in claim 4, wherein the strobilurin is of the formula Ia 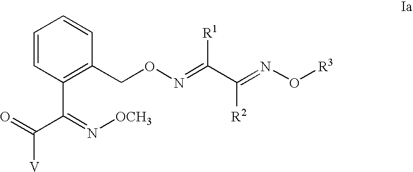
where
V is C₁₋C₄-alkylamino or C₁₋C4-alkoxy,
R₁ is hydrogen, halogen, cyano, C₁-haloalkyl or C₁-C₄-alkyl,
R² is halogen, C₁-C₄-alkyl, C₁-C₆-alkoxy C₁-C₆-alkenyl or C₁-C₄-haloalkyl, phenyl, halophenyl,
R³ is hydrogen, C₁-haloalkyl, C₁₋C₄-alkyl, cyclopropyl, C₃-C₄-alkenyl or C₃-C₄-alkynyl.

6. A method as claimed in claim 4, wherein the strobilurin is of the formula Ib 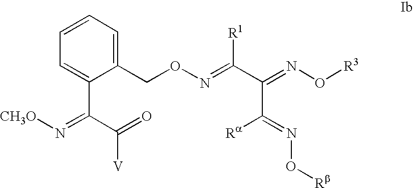
where
V is NHCH₃or OCH₃;
R¹ is hydrogen, cyano, halogen, C₁-haloalkyl or C₁-C₄-alkyl;
R³ is hydrogen, C₁-haloalkyl, cyclopropyl, C₁-C₄-alkyl, C₃-C₄-alkenyl, C₃-C₄-alkynl;
R^{α} is hydrogen, C₁-haloalkyl or C₁-C₄-alkyl;
R^{β} is hydrogen, C₁-haloalkyl, cyclopropyl, C₁-C₄-alkyl, C₃-C₄-alkenyl or C₃-C₄-alkynyl.

7. A method as claimed in claim 1, wherein a pesticidal active ingredient selected from the group consisting of imidacloprid, acetamiprid, nitenpyram, fipronil, carbofuran, carbosulfan, benfuracarb, thiacloprid, fludioxonil, tefuranitde, thiamethoxam,
(E)-1-(2-chlorothiazol-5-ylmethyl)-3-methyl-2-nitroguanidine and terafuranitdine is used as component (b).

8. A method as claimed in claim 1, wherein calcium carbonate, magnesium silicate or calcium sulfate is used as component (e).

9. A method for the preparation of a solid formulation of a crop protection product as claimed in claim 1, which comprises melting components (a), (b), (c), (d), (e) and (f) in an extruder to give a plastic mixture and subsequently comminuting the melt by extrusion granulation.

10. A solid formulation of a crop protection product prepared as claimed in claim 1.

11. A method of controlling phytopathogenic fungi, undesired plant growth, undesired attack by insects or mites and/or for regulating the growth of plants, which comprises allowing a formulation of a crop protection product as claimed in claim 10 in solid form to act on plants, their environment or on seed.

12. A method for controlling phytopathogenic fungi, undesired plant growth, undesired attack by insects or mites and/or for regulating the growth of plants wherein a solid formulation of a crop protection product as claimed in claim 10 is applied, in the form of spreadable granules, to soils which are permanently or temporarily flooded.
